(19) United States
(12) Patent Application Publication
(10) Pub. No.: US 2011/0298220 A1
(43) Pub. Date: Dec. 8, 2011

(54) Combined stranded gas and wind integrated system power plant

(76) Inventors: Dennis Anderson, Rapid City, SD (US); George William Shurr, Ellsworth, MN (US)

(21) Appl. No.: 12/802,568

(22) Filed: Jun. 8, 2010

(51) Int. Cl. H02K 7/18; H02J 3/38

(52) U.S. Cl. 290/1 A; 307/84

(57) ABSTRACT

A combined stranded gas and wind integrated system power plant is disclosed which may be used to capture energy from stranded natural gas in conjunction with wind energy to provide usable electricity which may be used either locally or transmitted to the grid.

### RELATED APPLICATIONS

This application relies for priority upon the Provisional Patent Application filed by Dennis D. Anderson and George W. Shurr entitled Combined stranded gas and wind integrated system (sic) power point (sic), Ser. No. 11/280,444, filed Nov. 4, 2009.

### BACKGROUND OF THE INVENTION

1. Field of the Invention

The present invention relates generally to alternative energy systems and more specifically to a combined stranded gas and wind integrated system power plant.

2. Background Information

Natural gas is valuable as an energy source and for other purposes. It is often located and extracted from underground sources. Natural gas is also a “byproduct” of oil production. Very often there is no natural gas pipeline near the oil field through which the natural gas may be transported and the gas is released into the air, flared, or injected into an underground formation. In some cases a source of natural gas is discovered but it is not economically feasible to exploit the discovery using conventional means, because there is insufficient gas of appropriate quality to justify the expense of collecting, scrubbing, and pressurizing the gas or of building the pipeline or trunk lines necessary to transport the gas to an existing pipeline.

Such natural gas is often referred to as stranded natural gas or SNG. SNG is natural gas which is found under conditions such as those described above where it is not economically feasible to develop the field, extract the gas, or build the infrastructure necessary to transport it to an existing pipeline. Impurities, low energy content, and small volume of gas often may result in a SNG accumulation which is currently not exploited. SNG is any known source of natural gas which is economically not feasible to develop under current conditions using conventional means. For purposes of this application, SNG also includes other potentially valuable gases which have a known location, but are not conventionally developed for economic reasons such as associated gas, biogenic gas, methane, and microbial methane.

Associated gas is usually methane, but can include ethane, propane, and butane and is gas which is associated with the normal production of oil. Biogenic gas is gas which is produced by microbes through a process known as methanogenesis where the microbes are no longer present. Microbial methane is gas which is also produced by microbes through the same process, but where the microbes are currently present.

Creating energy from wind is an ancient concept and has been the subject of much technological advancement in recent years. However, traditional wind farms can only create energy when the wind is blowing. In order to provide a consistent source of energy, wind farms are sometimes combined with other energy sources, such as fossil fuel, to create a stable source of energy. That is, fossil fuel is used to generate energy to supplement the energy from the wind farm when the wind is not sufficient to create a base level of energy without such supplementation. Such a system might be called an integrated power system as it integrates more than one energy source. An attempt to create such an integrated power system is disclosed in the patent to Jaunich (U.S. Pat. No. 6,605,880; Aug. 12, 2003).

The combined stranded gas and wind integrated system power plant of the instant invention solves the above related problems with wind energy and SNG by creating an integrated system power plant using both sources of energy. The ideal invention should provide a simple and efficient method of combining wind energy with energy from SNG to create a consistent supply of usable energy in the form of electricity. The ideal invention should also provide for a method of creating electricity which may be used locally or in the power grid. It should also be simple, reliable, inexpensive, and easy to operate and maintain.

### SUMMARY OF THE INVENTION

The combined stranded gas and wind integrated system power plant of the instant invention uses a combination of energy from SNG and wind to create a constant and reliable source of electricity. Of course, the system should be located near a source of SNG and where there is ordinarily sufficient wind to power a conventional wind turbine. The invention requires a method of capturing wind energy such as a wind turbine and a method of creating electricity from SNG such as a gas-fired generator. The wind turbine generates electricity when there is sufficient wind and the gas-fired generator is used to supplement the electricity from the wind turbine when necessary.

In addition to the wind turbine and the gas-fired generator, a power collection system and a substation are components of the combined stranded gas and wind integrated system power plant of the instant invention. The power collection system collects the voltage outputs from the wind turbine and the gas-fired generator and also controls both the wind turbine and the gas-fired generator. Some appropriate level of electricity production is selected and the power collection system controls the output of the gas-fired generator to insure that electricity from the gas-fired generator supplements electricity from the wind turbine when necessary to create the appropriate level of electricity production. Power from the power collection system may be used directly for local use. The substation is used to transform electricity the power collection system to make it compatible for local use or compatible for use and compatible for transmission to an existing power transmission network or grid.

One of the major objects of the present invention is to provide a simple and efficient method of combining wind energy with energy from SNG to create a consistent supply of usable energy in the form of electricity.

Another objective of the present invention is to provide for a method of creating electricity which may be used locally or in the power grid.

Another objective of the present invention is to provide a combined stranded gas and wind integrated system power plant which is simple, reliable, inexpensive, and easy to use and maintain.

These and other features of the invention will become apparent when taken in consideration with the following detailed description and the drawings.

### BRIEF DESCRIPTION OF THE DRAWINGS

FIG. 1 is a schematic view of the combined stranded gas and wind integrated system power plant of the instant invention.

### DESCRIPTION OF A PREFERRED EMBODIMENT

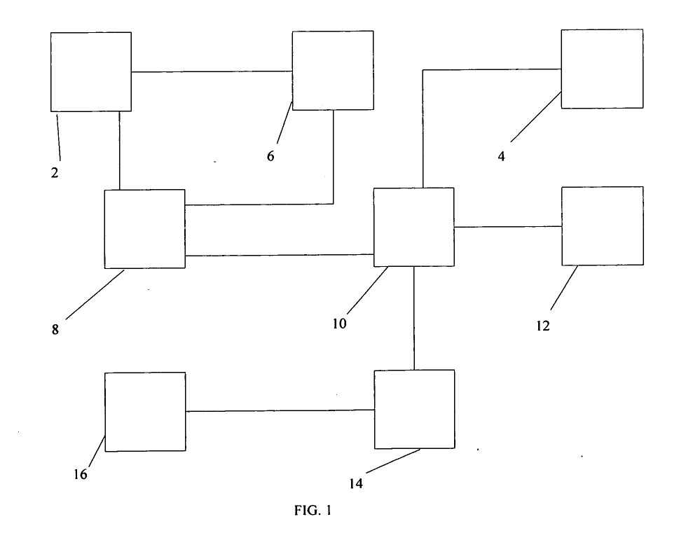

Referring to the drawing, FIG. 1, there is shown a schematic view of the combined stranded gas and wind integrated system power plant of the instant invention.

Now referring to FIG. 1, a schematic view of the combined stranded gas and wind integrated system power plant of the instant invention is shown. The instant invention must be located in a place where there is reasonable access to a source of stranded natural gas or SNG 2. As pointed out above, SNG may be any known accumulation or pocket of burnable gas which may be used to generate electricity where it is not economically feasible to exploit the gas in a conventional manner. In addition, the instant invention should be located in a place where there is sufficient wind to operate a wind generator such as a wind turbine 4. Although it is not necessary in all instances, the efficacy of the instant invention may be improved by including a gas storage facility 6. Excess SNG 2 may be stored in the gas storage facility 6 until needed.

Still referring to FIG. 1, a gas-fired generator 8 is provided which may be used to produce electricity using SNG 2 either directly or from said gas storage facility 6. The wind turbine 4 also produces electricity. Electricity from said wind turbine 4 and the gas-fired generator 8 are transmitted to a power collector 10. The power collector 10 has the capability of collecting power from said wind turbine 4 and said gas-fired generator 8 and transmitting it at a medium voltage of about 34.5 kV. Said power collector 10 is also capable of determining the amount of electricity produced by said wind turbine 4 and said gas-fired generator 8 controlling the amount of electricity produced by both said wind turbine 4 and said gas-fired generator 8. Said power collector 10 is capable of converting electricity to appropriate voltage and phase for either use locally or in the grid. Power collectors such as said power collector 10 are well known in the art and may either be purchased as a complete package or by buying components and putting them together. Said power collector 10 is further capable of producing power from either said SNG 2, said wind turbine 4, or from both. Local use 12 represents a direct user of the electricity transmitted from said power collector 10. In many instances electric power produced by the instant invention will be used by a “local” user. A local user may be a nearby manufacturing plant, government entity or facility, a small electric utility company, or similar user.

Still referring to FIG. 1, a substation 14 is also provided for those instances when there is not sufficient local use 12 to use all of the electric power generated through the instant invention. The substation 14 is capable of receiving medium voltage electricity from said power collector 10 and transforming it to a much higher voltage such that it may be transmitted to a power grid 16. The power grid 16 is power transmission network which is used to transmit electric power to most users of such power.

Prior to establishing a combined stranded gas and wind integrated system power plant of the instant invention, analysis of available SNG and wind energy should be done to establish a base line amount of electricity which may be produced. Said power collector 10 may be programmed to produce this base line amount. Said wind turbine 4 will most likely be used to produce the maximum power available from this source. Said gas-fired generator 8 will be used to supplement the power produced by said wind turbine 4 to produce the base line amount of electricity. That is, said gas-fired generator 8 will operate only at a level necessary to produce the base line amount when added to power provided by said wind turbine 4. Power from said power collector 10 may be then transmitted to said local use 12 as needed. Any excess power may be transmitted from said power collector 10 to said substation 14 and from said substation 14 to said power grid 16. Although there are variations on the use of such power, in most jurisdictions the power from said substation 14 may be sold on said power grid 16.

The elements of the instant invention are conventional and may be purchased from a number of suppliers. Generally, wind turbines are available in sizes from 10 KW to 5,000 KW (turbines may be purchased which are larger or smaller than this) and ordinarily include a gearbox, an electrical generator which converts the kinetic energy of the wind turbine to electrical power, a control system, and a braking system. Said power collector 10 is configured to be able to control the control system of said wind turbine 4. Ordinarily said wind turbine 4 may be ordered to provide electricity at a wide range of voltages. There may be more than one of said wind turbines 4 utilized with the instant invention. Gas-fired generators which may be used to convert SNG to electricity are well known and readily available. Said gas-fired generator 8 may actually be either a combustion turbine type generator or a reciprocating engine type generator. Most such generators come equipped with circuit breakers, relays, control systems, switchgear, disconnect switches, and any associated devices all of which are controlled by said power collector 10. As with wind turbines, gas-fired generators may be ordered such that they supply electricity at a variety of voltages and have capacities generally ranging from 60 KW to 1 MW. Said gas-fired generator 8 may include more than one electrical generator and may include various filtration means to prepare said SNG 2 for effective use. Said gas storage facility 6 may take any of a number of well known forms such as man-made storage vessels. Storage of SNG may be advisable in situations such as when said SNG 2 is available, but is not necessary because said wind turbine 4 is providing sufficient electricity. Devices such as said substation 14 are well known in the field and are readily available from a number of sources. Such substations include, among other things, transformers, circuit breakers, control systems and relays, switchgear, disconnect switches and insulators. Said power collector 10 is configured to be able to control the control systems and relays of said substation 14.

The number and size of said gas-fired generators 8 will be determined by the flow rate and cumulative volume of SNG available to the project. Additional factors, such as grid capacity, the power demand outline in a power purchase agreement (which would have to be addressed before electricity could be transmitted to the grid), the SNG production rate, and cumulative volume available from the SNG source, should be optimized to enhance overall economics and capacity of the project. Said gas-fired generators 8 generally vary in capacity from 60 KW to 1 MW, but in some instances they may be much larger. In many cases there will be more than one of said gas-fired generators 8 connected together and each would operate as needed. Preferably, said gas-fired generators 8 would be ultra low emission turbines similar to the Capstone Turbine manufactured by Capstone Turbine Corporation of 21211 Nordhoff Street, Chatsworth, Calif. which may burn gas that may be low in BTU's, have low pressure, have impurities, or be “sour” as it is delivered. The use of such gas-fired generators usually eliminates the need for normal scrubbing, treating, and pressurization which is ordinarily required for generators that use pipeline quality gas.

While preferred embodiments of this invention have been shown and described above, it will be apparent to those skilled in the art that various modifications may be made in these embodiments without departing from the spirit of the present invention. That is, the device could be used for a wide variety of purposes either in combination or separately.

We claim:

1. A combined stranded gas and wind integrated system power plant for use with stranded natural gas or any other burnable gas which is currently not economically feasible to exploit, both referred to as SNG comprising:
(1) at least one wind turbine capable of producing electricity from wind energy;
(2) at least one gas-fired generator capable of burning the SNG to produce electricity; and
(3) a power collection system capable of controlling both the wind turbine and the gas-fired generator such that they may controlled to provide a certain amount of electricity using power from either said wind turbine, from said gas-fired generator, or from both and further capable of transforming electricity produced to be used locally.

2. A combined stranded gas and wind integrated system power plant for use with stranded natural gas or any other burnable gas which is currently not economically feasible to exploit, both referred to as SNG comprising:
(1) at least one wind turbine capable of producing electricity from wind energy;
(2) at least one gas-fired generator capable of burning the SNG to produce electricity; and
(3) a power collection system capable of controlling both the wind turbine and the gas-fired generator such that they may controlled to provide a certain amount of electricity using power from either said wind turbine, from said gas-fired generator, or from both and further capable of transforming electricity produced to be transmitted to the power grid.

3. A combined stranded gas and wind integrated system power plant for use with stranded natural gas or any other burnable gas which is currently not economically feasible to exploit, both referred to as SNG comprising:
(1) at least one wind turbine capable of producing electricity from wind energy;
(2) at least one gas-fired generator capable of burning the SNG to produce electricity; and
(3) a power collection system capable of controlling both the wind turbine and the gas-fired generator such that they may controlled to provide a certain amount of electricity using power from either said wind turbine, from said gas-fired generator, or from both and further capable of transforming electricity produced to be used locally or transmitted to the power grid.

4. The combined stranded gas and wind integrated system of claim 1 in which storage is provided for the SNG and SNG from the storage is used by said gas-fired generator.

5. The combined stranded gas and wind integrated system of claim 2 in which storage is provided for the SNG and SNG from the storage is used by said gas-fired generator.

6. The combined stranded gas and wind integrated system of claim 3 in which storage is provided for the SNG and SNG from the storage is used by said gas-fired generator.

7. The combined stranded gas and wind integrated system of claim 2 in which a substation is provided which is capable of transforming electricity to the appropriate voltage and phase for transmission to the grid.

8. The combined stranded gas and wind integrated system of claim 3 in which a substation is provided which is capable of transforming electricity to the appropriate voltage and phase for transmission to the grid.
